(19) United States
(12) Patent Application Publication
(10) Pub. No.: US 2024/0383255 A1
(43) Pub. Date: Nov. 21, 2024

(54) INKJET HEAD CHIP IDENTIFICATION CIRCUIT

(71) Applicant: Microjet Technology Co., Ltd., Hsinchu (TW)

(72) Inventors: Hao-Jan Mou, Hsinchu (TW); Cheng-Ming CHANG, Hsinchu (TW); Wen-Hsiung LIAO, Hsinchu (TW)

(73) Assignee: Microjet Technology Co., Ltd., Hsinchu (TW)

(21) Appl. No.: 18/660,892

(22) Filed: May 10, 2024

(30) Foreign Application Priority Data
May 16, 2023 (TW) 112118196
May 16, 2023 (TW) 112118197

(51) Int. Cl. B41J 2/175

(52) U.S. Cl. CPC B41J 2/17546; B41J 2202/17

(57) ABSTRACT

An inkjet head chip identification circuit is disclosed and includes an identification circuit matching with a printer so that the printer provides an inkjet head chip with required information according to the matching result. The identification circuit includes plural memory units. The memory units arranged in an array structure and include a first transistor, a third transistor, a fuse or a combination thereof. By burning the elements in the array structure or not, a data signal of each memory unit is read. The first transistor is a MOSFET-Anti-Fuse. The third transistor is an EPROM. The first transistor, the third transistor and the fuse are formed on the same inkjet head chip.

### CROSS-REFERENCE TO RELATED APPLICATION

This application claims priority to Taiwan Patent Application No. 112118196, filed on May 16, 2023, and claims priority to Taiwan Patent Application No. 112118197, filed on May 16, 2023. The entire contents of the above-mentioned patent applications are incorporated herein by reference for all purposes.

### FIELD OF THE INVENTION

The present disclosure relates to an inkjet head chip identification circuit, and more particularly to an inkjet head chip identification circuit which could increase the ink cartridge data recording flexibility and the data security by improving the structure of the memory units in the inkjet head chip.

### BACKGROUND OF THE INVENTION

Inkjet printing technology, often referred to as “Inkjet Printing”, is a widely used printing technology. The history of inkjet printing with its origins tracking back to the 1950s when the British component of HP (Hewlett-Packard) invented inkjet printing technology. Since then, the inkjet printing technology has developed rapidly, and the inkjet printers have become the mainstream technology for home and commercial printing. The inkjet printers have many advantages, such as the cost-effectiveness, especially for home and small business use. Also, the inkjet printers have high printing quality, and can provide high-resolution and high-quality images, especially in photos or pictures. Furthermore, the inkjet printers are convenient to use and easy to install, most of inkjet printers can print through computers or mobile devices. In addition, the combination of the inkjet printers and a business machines with all-in-one functions (including fax, photocopying, and scanning) that have emerged in recent years can quickly expand the flexibility of paperwork in the office.

The inkjet head identification circuit in an inkjet printer is a crucial component in inkjet printing technology. Since each type of inkjet printer requires a corresponding inkjet head, and each inkjet head has its own special specifications, including characteristics of the structure, the ink used, the number of nozzles and the control circuits. Therefore, a compatible printing system is required to operate together with the inkjet printer through the inkjet head identification circuit. Specifically, the inkjet head identification circuit includes fuses, transistor-anti-fuses and related circuit components, which are used to store information including but not limited to the ink cartridge serial number, the ink type, the ink capacity, the ink color, and the matching table of inkjet head-inkjet printer, so as to ensure the printing quality and the efficiency.

Please refer to FIG. 1A and FIG. 1B, which illustrate memory units included in an ink cartridge identification circuit according to the prior art. The memory units 100 are configured to store the above-mentioned information of the ink cartridge serial number, the ink type, and the matching table of inkjet head-inkjet printer. The memory unit 100 includes an identification signal terminal 110, a data terminal 120, a fuse 130 and a transistor device 140. In more detail, when the data terminal 120 provides a high potential, the transistor device 140 is operated in a conductive state, if the identification signal terminal 110 provides a low potential at the same time, the memory unit 100 dose not perform a programming operation. On the other hand, when the data terminal 120 provides a high potential, the transistor device 140 is operated in a conductive state, if the identification signal terminal 110 provides a programming potential, the memory unit 100 would perform a programming operation, as shown in FIG. 1B. When the memory units 100 are read, if the data terminal 120 provides a high potential, and the transistor device 140 is operated in a conductive state. At this time, if the identification signal terminal 110 reads the unblown fuse 130, it will detect a low voltage. Otherwise, if a blown fuse is detected, it will read a high voltage. Accordingly, the memory units 100 can control whether the fuse 130 is blown or not to transmit a transmission signal with the high potential or the low potential and represent the information in each bit in the memory units 100, achieving the purpose of recording information.

However, the aforementioned ink cartridge identification circuit still includes the following shortcomings. Although recording information by controlling whether the fuse is blown or not in the memory units 100 can indeed output a signal with the high potential or the low potential, the amount of information contained in the inkjet printer is increasing as its functions become increasingly sophisticated, obviously, it is not enough to rely solely on the fuses 130 to record information in the future. From the perspective of industrial utilization, the patterns and the sequences of the fuses 130 for identifying whether the circuit is blown or not in the ink cartridge can be imitated through reverse engineering, and the matching information between the inkjet head and the inkjet printer can be easily obtained, as a result, in addition to infringing on the intellectual property of the enterprise, users may also purchase inferior ink cartridges, and the printing quality and rights are affected resulting in causing the enterprises or the users who use the inkjet printers to suffer economic or intellectual property losses. Moreover, once the fuse 130 is blown, it means that the information in the memory units 100 cannot be modified, if there is an operation or an information writing error in the software used with the ink cartridge identification circuit, no correction can be made. However, compared with other recording methods, the fuse 130 has the advantages of easy operation and low cost owing to the simple structure and the operating principle. Therefore, in the current market, there is an urgent need of providing inkjet head chip identification circuit set in an identical chip, and capable of being modified appropriately according to the application situation while the economic cost is maintained. At the same time, the advantages of easy operation and low cost of the identification circuit for the same ink cartridge are maintained, and the information recording and security of the inkjet head chip identification circuit is improved sufficiently.

### SUMMARY OF THE INVENTION

Based on the above reasons, the present disclosure provides an inkjet head chip identification circuit, by improving the memory units in the inkjet head, the diversity of circuit components in the memory unit is increased. At the same time, the memory units have a correctable function. In addition, without increasing the manufacturing cost, the recorded information of an ink cartridge serial number, an identification code, an ink type, an ink capacity, an ink color, a number of nozzles, a manufacturing date, a factory date, an ink cartridge capacity change, and a number of used times that the ink cartridge has been used on a machine are more detailed and complete. It can also increase the difficulty of reverse engineering imitation of the inkjet head chip identification circuit and improve the effectiveness of intellectual property protection. In an embodiment, the inkjet head chip identification circuit includes the following components: an identification circuit matching with a printer, so that the printer provides an inkjet head chip with required information according to a matching result. In an embodiment, the identification circuit comprises a plurality of memory units, and the memory units are arranged in an array structure. Furthermore, the plurality of memory units further includes a first transistor, a third transistor, a fuse or a combination thereof. A data signal of each memory unit is controlled and read by burning the first transistor, the third transistor and the fuse or not, so that the information recorded in the identification circuit is determined. In the embodiments of the present disclosure, the first transistor is a MOSFET-Anti-Fuse, and the third transistor is an erasable programmable read only memory (EPROM). Moreover, the first transistor, the third transistor and the fuse are formed on the same inkjet head chip.

In accordance with an aspect of the present disclosure, the first transistor is a metal oxide semi-field effect transistor (MOSFET), and selected from an N-type metal oxide semi-field effect transistor (NMOSFET) or a P-type metal oxide semi-field effect transistor (PMOSFET) according to the practical requirements. In addition, the third transistor is an erasable programmable read only memory (EPROM). Furthermore, the fuse is selected from a polycrystalline silicon fuse (poly-fuse) or a metal fuse (metal fuse) according to the practical requirements.

In accordance with an aspect of the present disclosure, each memory unit further includes an identification signal terminal, a data terminal and a second transistor. The identification signal terminal is connected to the fuse, the first transistor or the third transistor to provide an identification potential. The data terminal is connected to a gate of the second transistor. The first transistor, the third transistor and the fuse are connected to the second transistor.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1A illustrates a circuit architecture of a memory unit before programming according to the prior art;

FIG. 1B illustrates a circuit architecture of the memory unit after programming according to the prior art;

FIG. 2A illustrates an inkjet head chip identification circuit matching with a printer through an identification circuit, so that the printer provides an inkjet head chip with required information according to a matching result;

FIG. 2B illustrates an array structure formed by the memory units contained in the identification unit to record information in the inkjet head;

FIG. 3A illustrates a circuit architecture of the memory unit according to an embodiment of the present disclosure;

FIG. 3B illustrates a circuit architecture of the memory unit according to an embodiment of the present disclosure;

FIG. 3C illustrates a circuit architecture of the memory unit according to an embodiment of the present disclosure;

FIG. 3D illustrates a circuit architecture of the memory unit according to an embodiment of the present disclosure;

FIG. 3E illustrates a circuit architecture of the memory unit having the third transistor, that is an EPROM, used therein according to an embodiment of the present disclosure;

FIG. 3F illustrates a circuit architecture of the memory unit having the fuse used therein according to an embodiment of the present disclosure;

FIG. 4A illustrates a cross-sectional structure of the N-type MOSFET before burning in the present disclosure;

FIG. 4B illustrates a cross-sectional structure of the N-type MOSFET after burning in the present disclosure;

FIG. 5A illustrates a cross-sectional structure of the P-type MOSFET before burning in the present disclosure;

FIG. 5B illustrates a cross-sectional structure of the P-type MOSFET after burning in the present disclosure;

FIG. 5C illustrates a cross-sectional structure of the EPROM in the present disclosure;

FIG. 6 illustrates an array structure of the memory units including the first transistors, the third transistors and the fuses according to an embodiment of the present disclosure; and

FIG. 7 illustrates an array structure of the memory units including the first transistors, the third transistors and the fuses according to another embodiment of the present disclosure.

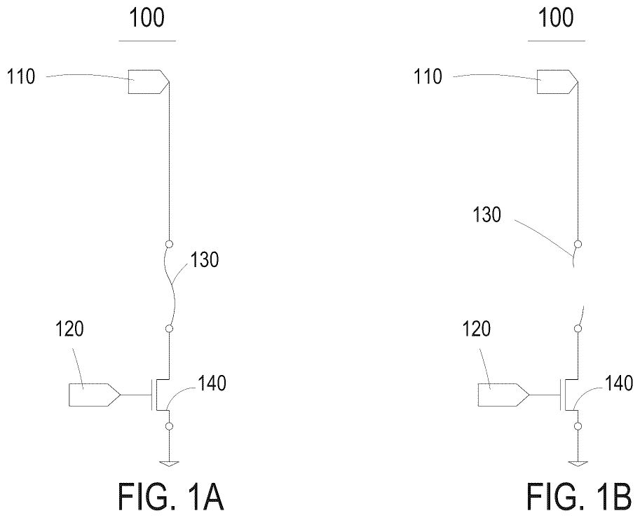

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. In addition, the present disclosure can also be applied and implemented through other specific embodiments. Various details described in this specification can also be applied based on different needs, and various modifications or changes can be made without departing from the spirit of the present disclosure. Therefore, the present disclosure will be described in several preferred embodiments and perspectives. Such descriptions used to explain the structure of the present disclosure are only used to illustrate, but not to limit the patentable scope of the present disclosure. The terms used in the following descriptions are to be interpreted in the broadest reasonable manner, so that those terms can be used in connection with the detailed descriptions of a particular embodiment of the present disclosure. Those skilled in the art can adjust the structure of the present disclosure according to manufacturing or application requirements to meet the needs of the actual industry. In this specification, the fuse mentioned can be referred to as Fuse, and the first transistor can be referred to as MOS or MOSFET. In case of that the first transistor is a transistor anti-fuse (MOSFET Anti-Fuse), it can also be referred to as MOSFET-Anti-Fuse or MOSFET Anti-Fuse. Similarly, in case of that the third transistor is an erasable programmable read only memory, it can be referred to as EPROM.

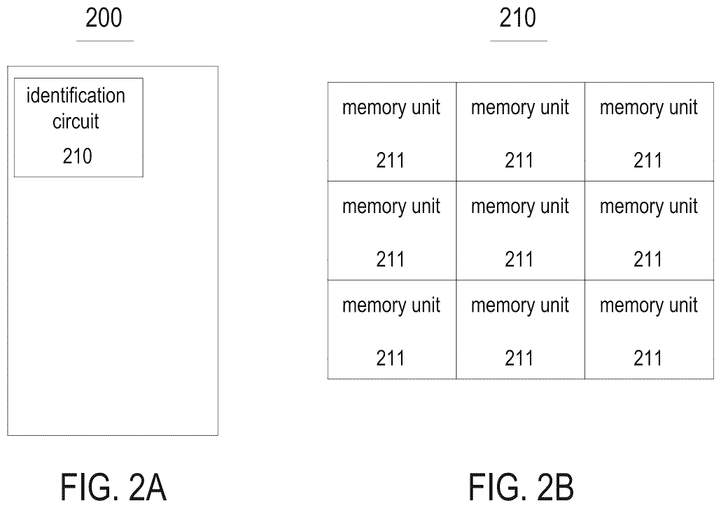

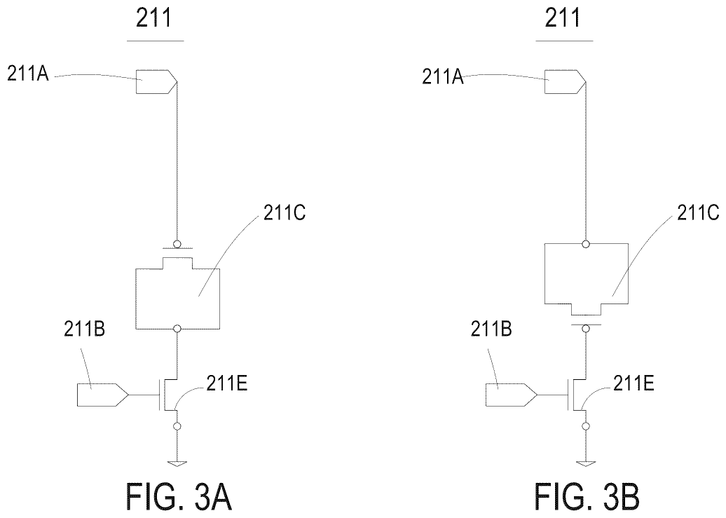

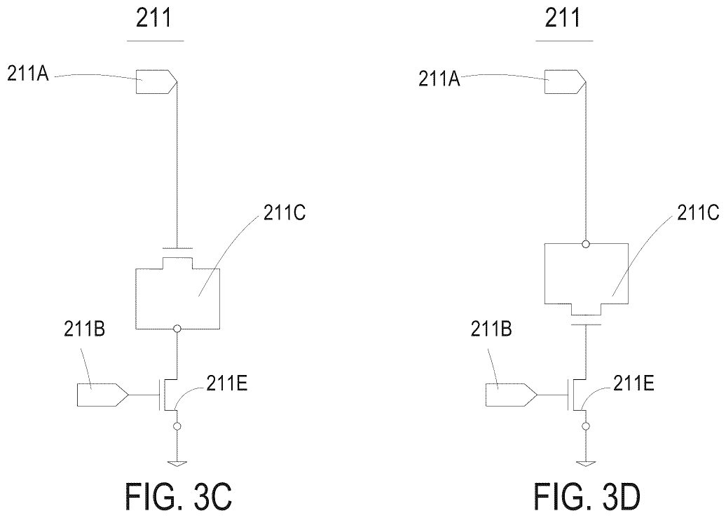

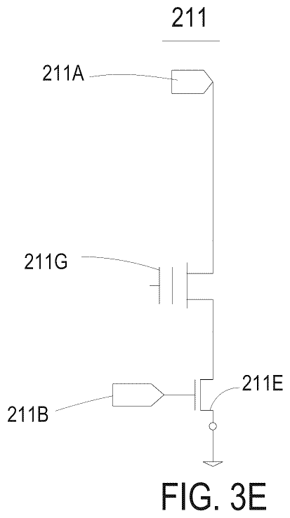

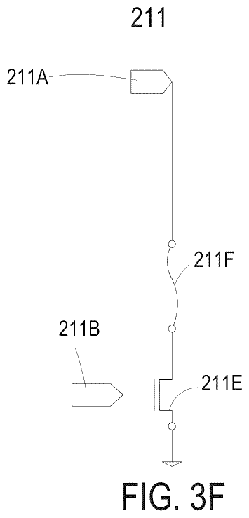

Please refer to FIG. 2A, FIG. 2B, FIG. 3A, FIG. 3B, FIG. 3C, FIG. 3D, FIG. 3E and FIG. 3F. In an embodiment, the present disclosure provides an inkjet head chip identification circuit 200 including the following components. The inkjet head chip identification circuit 200 includes an identification circuit 210 matching with a printer, so that the printer provides an inkjet head chip with required information according to a matching result. In the embodiment, the identification circuit 210 includes a plurality of memory units 211, and the memory units 211 are arranged in an array structure. Preferably but not exclusively, the array structure further includes a first transistor 211C, a third transistor 211G, a fuse 211F or a combination thereof. By burning or not burning the first transistor 211C, the third transistor 211G and the fuse 211F, the memory units 211 are controlled to output data signals. According to the array structure formed by the memory units 211, the identification circuit 210 can provide the information, for example but not limited to an ink cartridge serial number, an identification code, an ink type, an ink capacity, an ink color, a number of nozzles, a manufacturing date, a factory date, an ink cartridge capacity change, a number of used times that the ink cartridge has been used on a machine, and a combination thereof. It allows the inkjet printer to identify information such as the model and type of the inkjet head in the ink cartridge. In the embodiment, the first transistor 211C is a MOSFET-Anti-Fuse, and the third transistor 211G is (EPROM). Furthermore, the fuse 211F is selected from a polycrystalline silicon fuse (poly-fuse) or a metal fuse (metal fuse), and the first transistor 211C, the third transistor 211G and the fuse 211F are formed on the same inkjet head chip.

According to one aspect of the present disclosure, in the inkjet head chip identification circuit 200 of the present disclosure, the MOSFET-Anti-Fuse selected for the first transistor 211C and the fuse 211F are mainly configured to record unchangeable information in the inkjet head chip, preferably but not exclusively, the unchangeable information includes the ink cartridge serial number, the identification code, the ink type, the ink capacity, the ink color, the number of nozzles, the manufacturing date, the factory date, or a combination thereof. On the other hand, since the EPROM selected for the third transistor 211G has a different resistance value every time when it is burned, it is mainly configured to record changeable information in the inkjet head chip. Preferably but not exclusively, the changeable information includes the ink cartridge capacity change, the number of used times that the ink cartridge has been used on the machine, or a combination thereof. Whether the MOSFET Anti-Fuse and the EPROM have been programmed or not cannot be discerned from the outward appearance of the inkjet printhead chip. Furthermore, specific software or algorithms are required for reading, programming, or using the inkjet printhead chip. From the perspective of intellectual property rights and industrial utilization, even if an information security attacker copies all the fusing patterns and the sequences of the fuse 211F in the present disclosure, the inkjet head chip of the present disclosure cannot be counterfeited through reverse engineering without the information on whether MOSFET-Anti-Fuse and EPROM have been burned. Accordingly, the present invention enhances the information security, protecting the rights and interests of both consumers and manufacturers in the industry. Moreover, the purposes of making the encryption function of the ink cartridge and recording the more complete information are achieved. At the same time, the fuses 211F, with the advantages of simple structure and easy cost control, are used for recording the unchangeable information in the inkjet head chip.

Please refer to FIG. 3A, FIG. 3B, FIG. 3C and FIG. 3D. In the embodiments of the present disclosure, the first transistors 211C in FIG. 3A and FIG. 3B are P-type, and the first transistors 211C in FIG. 3C and FIG. 3D are N-type. In addition, FIG. 3E illustrates an embodiment of the present disclosure when the third transistor 211G in the circuit structure of the memory unit 211 adopts EPROM. Moreover, in order to provide the functions of programming the first transistor 211C and the third transistor 211G in the embodiment of the present disclosure, each memory unit 211 further includes an identification signal terminal 211A, a data terminal 211B, and a second transistor 211E. In the embodiment, the identification signal terminal 211A is configured to transmit an identification potential, and is connected to the first transistor 211C, the third transistor 211G and the fuse 211F in the memory unit 211, so as to control burning/non-burning of the first transistor 211C, the third transistor 211G or fuse 211F. In addition, the data terminal 211B is configured to transmit a data potential, and is connected to a gate G of the second transistor 211E. Moreover, the first transistor 211C, the third transistor 211G or the fuse 211F is connected to the second transistor 211E. In the embodiment, the memory unit 211 controls the output of the data signal by regulating the data potential and the identification potential. In some embodiments of the present disclosure, the first transistor 211C is selected from a metal oxide semi-field effect transistor (MOSFET), and also selected from n N-type metal oxide semi-field effect transistor (NMOSFET) or a P-type metal oxide semi-field effect transistor (PMOSFET). Moreover, the third transistor 221G is an erasable programmable read only memory (EPROM). In the above-mentioned embodiments, the first transistors 211C, the third transistors 211G and the fuses 211F can be selected from the above types to form the array structure in the memory units 211 and combined arbitrarily according to the practical requirements, thereby improving the flexibility of information recording.

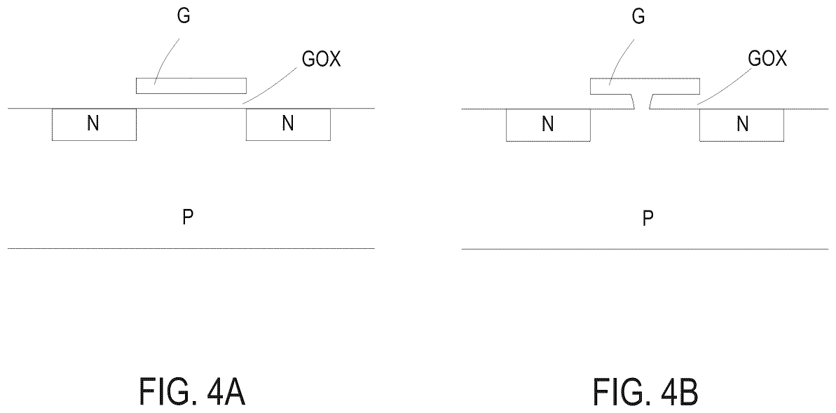

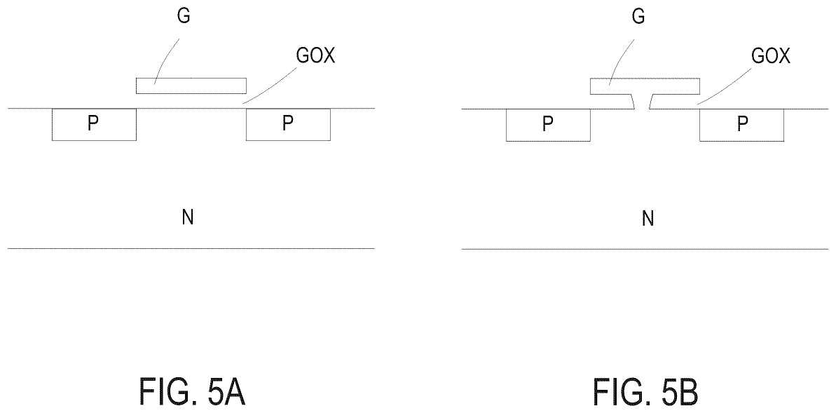

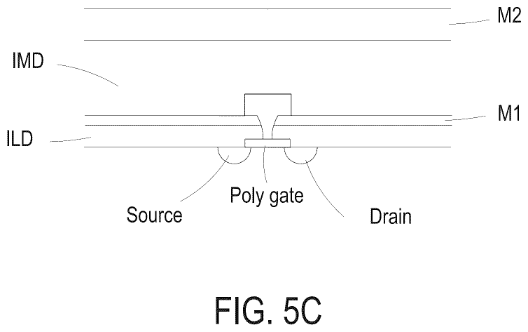

Please refer to FIG. 4A, FIG. 4B, FIG. 5A and FIG. 5B. The states of the first transistors 211C, which is programmed and not programmed in the memory unit 211, are illustrated. Depending on the state, the memory unit 211 is allowed to output a binary digit data signal. In the embodiments of FIG. 4A and FIG. 4B, the first transistor 211C is an N-type metal oxide semiconductor field effect transistor. As shown in FIG. 4A, there is a gate oxide layer GOX at the lower end of the gate G of the first transistor 211C. When the identification potential provided by the identification signal terminal 211A is less than a collapse potential, the gate oxide layer GOX is in an intact state. At this time, if the data terminal 211B provides a high potential, the second transistor 211E will be in a conductive state, and the identification signal terminal 211A will be read out of a high resistance state in the memory unit 211. Notably, the data signal outputted indicates that the corresponding memory unit 211 is in an unburned state. On the other hand, as shown in FIG. 4B, when the identification potential provided by the identification signal terminal 221A is greater than a collapse potential, the gate oxide layer (GOX) in a collapsed state. In that, the gate G is connected to the substrate of the first transistor 211C to generate an irreversible damage. At this time, the identification signal terminal 211A is read out of a low resistance state in the corresponding memory unit 211, and the data signal outputted indicates that the corresponding of memory unit 211 is in a programmed state. The purpose of outputting binary data signals is achieved. Notably, in the present disclosure, the binary data signals of 0 and 1 do not necessarily correspond to the low resistance or the high resistance, alternatively, the binary data signals of 1 and 0 also could correspond to the low resistance or the high resistance, respectively. Certainly, the corresponding relationship can be set, changed or modified according to the practical requirements. Moreover, in FIG. 5A and FIG. 5B, the first transistor 211C is an P-type metal oxide semiconductor field effect transistor. Similarly, the magnitude of the potential provided by the identification signal terminal 211A can be regulated to control whether the gate oxide layer GOX is collapsed, thereby burning/unburning the memory unit 211. In this way, the purpose of controlling the output of binary data signals is achieved. Since the burning/unburning mechanism of the P-type metal oxide semi-field effect transistor is similar to that of the N-type metal oxide semi-field effect transistor, it will not be redundantly described hereafter.

Please refer FIG. 5C. It illustrates a cross-sectional structure of the third transistor 211G in the present disclosure. In the embodiment of the present disclosure, in case of that the third transistor 211G is an EPROM, the third transistor 211G includes a source (Source), a drain (Drain), a polycrystalline silicon gate (Poly gate), a floating gate M1, a first dielectric layer ILD, a control gate M2 and a second dielectric layer IMD. Preferably but not exclusively, in the embodiment, the source and the drain are selected form N-type or P-type semiconductors. The first dielectric layer ILD is disposed between the polycrystalline silicon gate (Poly gate) and the floating gate M1. The second dielectric layer ILD is disposed between the floating gate M1 and the control gate M2. Moreover, the polycrystalline silicon gate (Poly gate) is used to connect the source and the drain, and the floating gate M1 and the control gate M2 are made of metal materials. In an embodiment of the present disclosure, N-type semiconductors are used as the source and the drain for illustration. When the burning mechanism starts, a high potential is provided to the drain. At this time, the electrons are moved from the source to the drain through the polycrystalline silicon gate. Under the action of the high potential, the pulling force of moving with the electrons is strengthened, and the energy will increase the temperature of the electrons, so as to form hot electrons. Then, a high voltage is provided to the control gate M2, and the hot electrons will overcome the potential energy of the first dielectric layer ILD and transmitted to the floating gate M1. At this time, if the high potentials of the control gate M2 and the drain are turned off, the hot electrons will be bound (stored) in the floating gate M1 to complete the burning process. After the burning of the third transistor 211G is completed, the value of a high resistance (high) is read. This is in contrast to the low resistance reading value of floating gate M1 before programming without the hot electrons. In this way, it allows the memory unit 211 outputting a binary digit data signal. Similarly, the above-mentioned binary data signals of 0 and 1 do not necessarily correspond to the low resistance or the high resistance, alternatively, the binary data signals of 1 and 0 also could correspond to the low resistance and the high resistance, respectively. Certainly, the corresponding relationship can be set, changed or modified according to the practical requirements. In addition, when the EPROM of the third transistor 211G is programmed multiple times, its resistance value will change when reading. It can be used to record the changeable information in the inkjet head chip during repeated programming. Preferably but not exclusively, the changeable information in the inkjet head chip includes the ink cartridge capacity change, the number of used times that the ink cartridge has been used on the machine, or a combination thereof.

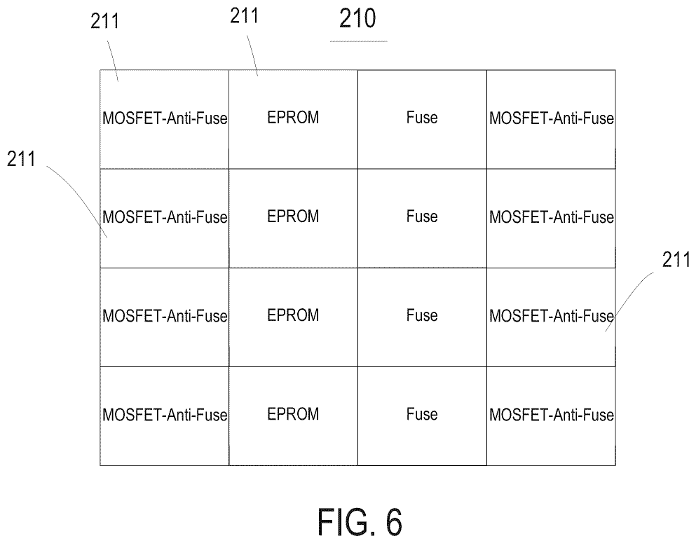

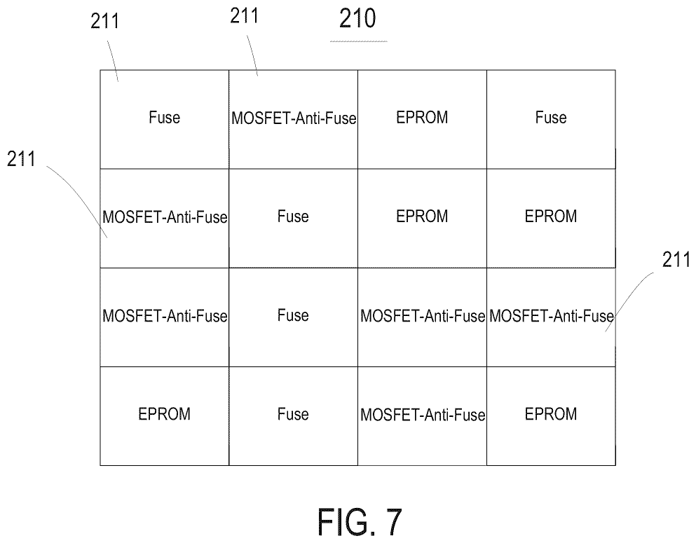

Please refer to FIG. 6 and FIG. 7, the illustrations demonstrate the array structure formed by the plurality of memory units 211 in the identification circuit 210. In the embodiment, the array structure includes a combination of the fuses 211F, the first transistors 211C (i.e., the MOSFET-Anti-Fuse), and a third transistors 211G (i.e., the EPROM). As shown in the combination of the identification circuit 210 of FIG. 6 and FIG. 7, the diversity of each memory unit 211 in the identification circuit 210 can be increased. That is to say, when the array structure of the identification circuit 210 has N memory units 211, it means that the arrangement of the array structure can have multiple ways of recording data. Such an architecture of the present disclosure has several benefits. Firstly, from the perspective of economic reasons, the manufacturing cost of the identification circuit 210 that allows Fuse, MOSFET-Anti-Fuse, and EPROM to coexist can be maintained at the same level as the previous technology that only uses the fuses 130. From the perspective of data signal recording, since the identification circuit 210 has more programming options, it allows the identification circuit 210 to record more and more complete information, such as the ink cartridge serial number, the identification code, the ink type, the ink capacity, the ink color and the inkjet head temperature. Finally, from the perspective of information security and intellectual property, since the inkjet head chip identification circuit 200 needs to be matched with relevant identification software, identification programs or identification algorithms during the process of matching with the inkjet printer, the programming types and the diversity of the identification circuit 210 are increased. The inkjet head chip identification circuit 200 combined with the above-mentioned calculation mechanism can also improve the rigor of information security encryption, thereby protecting the company's intellectual property and the related rights and interests of users. Notably, the array structure includes the plurality of memory units 211 in FIG. 6 is only an example for illustration. In the actual application of the present disclosure, the arrangement position (i.e., the selection mode of each memory unit 211) and the number of bits of Fuse, MOSFET-Anti-Fuse and EPROM in the array structure will not be limited. For example, FIG. 6 shows one aspect of the present disclosure. FIG. 7 is another implementation of the above descriptions. Therefore, those skilled in the art can make selections or modifications based on the actual applications after reading the descriptions.

In summary, the present disclosure provides an inkjet head chip identification circuit increasing the ink cartridge data recording flexibility and the data security in the conventional inkjet head chip by improving the structure of the memory units therein. While the disclosure has been described in terms of what is presently considered to be the most practical and preferred embodiments, it is intended to cover various modifications and similar arrangements included within the spirit and scope of the appended claims which are to be accorded with the broadest interpretation so as to encompass all such modifications and similar structures.

What is claimed is:

1. An inkjet head chip identification circuit, comprising:
an identification circuit matching with a printer, so that the printer provides an inkjet head chip with required information according to a matching result,
wherein the identification circuit comprises a plurality of memory units, and the memory units are arranged in an array structure,
wherein the plurality of memory units further comprise a first transistor, a third transistor, a fuse or a combination thereof, the first transistor is a MOSFET-Anti-Fuse, and the third transistor is an erasable programmable read only memory (EPROM), wherein a data signal of each memory unit is controlled and read by burning the first transistor, the third transistor and the fuse or not, wherein the first transistor, the third transistor and the fuse are formed on the same inkjet head chip.

2. The inkjet head chip identification circuit according to claim 1, wherein the first transistor is selected from an N-type metal oxide semi-field effect transistor (NMOSFET) or a P-type metal oxide semi-field effect transistor (PMOSFET).

3. The inkjet head chip identification circuit according to claim 1, wherein the third transistor includes a source, a drain, a polycrystalline silicon gate, a floating gate, a first dielectric layer, a control gate and a second dielectric layer; wherein, the first dielectric layer is disposed between the polycrystalline silicon gate and the floating gate, the second dielectric layer is disposed between the floating gate and the control gate and the polycrystalline silicon gate is connected to the source and the drain.

4. The inkjet head chip identification circuit according to claim 3, wherein the floating gate and the control gate are made of metal materials.

5. The inkjet head chip identification circuit according to claim 1, wherein the fuse is selected from a polycrystalline silicon fuse (poly-fuse) or a metal fuse (metal fuse).

6. The inkjet head chip identification circuit according to claim 1, wherein the plurality of memory units further comprise:
an identification signal terminal connected to the fuse, the first transistor or the third transistor to provide an identification potential;
a data terminal providing a data potential; and,
a second transistor, wherein the second transistor is connected to the fuse, the first transistor or the third transistor, and a gate of the second transistor is connected to the data terminal;
wherein the plurality of memory units read the data signal by regulating the data potential and the identification potential.

7. The inkjet head chip identification circuit according to claim 6, wherein when the identification signal terminal is connected to the first transistor, the identification potential is less than a collapse potential, and the data terminal provides a high potential, the identification signal terminal is read out of a high resistance state in the corresponding memory unit, and the data signal outputted indicates that the corresponding memory unit is in an unburned state.

8. The inkjet head chip identification circuit according to claim 7, wherein the first transistor has a gate oxide layer (GOX) in an intact state.

9. The inkjet head chip identification circuit according to claim 6, wherein when the identification signal terminal is connected to the first transistor and the identification potential is greater than a collapse potential, the identification signal terminal is read out of a low resistance state in the corresponding of memory unit, and the data signal outputted indicates that the corresponding memory unit is in a programmed state.

10. The inkjet head chip identification circuit according to claim 9, wherein the first transistor has a gate oxide layer (GOX) in a collapsed state.

11. The inkjet head chip identification circuit according to claim 1, wherein the information recorded by the identification circuit comprises one selected from the group consisting of an ink cartridge serial number, an identification code, an ink type, an ink capacity, an ink color, a number of nozzles, a manufacturing date, a factory date, an ink cartridge capacity change, a number of used times that the ink cartridge has been used on a machine, and a combination thereof.

12. The inkjet head chip identification circuit according to claim 11, wherein the first transistor records unchangeable information in the inkjet head chip, and the unchangeable information comprises the ink cartridge serial number, the identification code, the ink type, the ink capacity, the ink color, the number of nozzles, the manufacturing date, the factory date, or a combination thereof.

13. The inkjet head chip identification circuit according to claim 11, wherein the third transistor records changeable information in the inkjet head chip, and the changeable information comprises the ink cartridge capacity change, the number of used times that the ink cartridge has been used on the machine, or a combination thereof.
